(19) United States
(12) Patent Application Publication
(10) Pub. No.: US 2018/0096581 A1
(43) Pub. Date: Apr. 5, 2018

(54) LONG RANGE WIRELESS NOTIFICATION SYSTEM AND METHOD FOR ELECTRONIC RODENT TRAPS

(71) Applicant: WOODSTREAM CORPORATION, Lititz, PA (US)

(72) Inventor: Thomas J. DALY, JR., Lititz, PA (US)

(73) Assignee: WOODSTREAM CORPORATION, Lititz, PA (US)

(21) Appl. No.: 15/711,601

(22) Filed: Sep. 21, 2017

Related U.S. Application Data
(60) Provisional application No. 62/402,428, filed on Sep. 30, 2016.

(51) Int. Cl. G08B 21/18; H04L 29/08; A01M 23/00; A01M 31/00

(52) U.S. Cl. CPC G08B 21/18; H04L 67/125; H04W 84/18; A01M 31/002; A01M 23/00

(57) ABSTRACT

A long range wireless notification electronic rodent trapping system and method is provided having a plurality of rodent trapping devices configured to wirelessly communicate trap information to a gateway that can be in communication with a cloud server. The system uses frequencies of less than 1 GHz and data packets with a payload of not more than 256 bytes to enable the status of the traps to be remotely monitored over a wide geographical area with the traps being capable of reporting their status directly to a gateway located up to about 10 miles away.

This application claims the priority of U.S. Provisional Application Ser. No. 62/402,428 filed Sep. 30, 2016.

### BACKGROUND OF THE INVENTION

### Field of the Invention

The present invention is related to the field of pest control and pest trap monitoring and, more particularly, to a remote notification electronic rodent trapping system and method having electronic rodent traps with long range wireless communication and trap status monitoring capability.

### Description of the Related Art

Rodent trap monitoring has typically required that the user come in close proximity to the trap to determine whether or not a rodent has been dispatched or the trap deactivated. Physically checking rodent traps can be inconvenient, particularly when the traps are located in a barn, attic, basement, crawl space, etc. Trap monitoring can also be very time consuming for users such as professional rodent control companies who place traps at multiple sites and then must physically visit each site on a regular basis to monitor the status of the traps and ensure traps are in an operational-ready state.

To address the problems associated with manual trap checking, electronic rodent control systems have been equipped with wireless communication. However, many state of the art wireless notification systems used in connection with rodent traps have very limited range due to the ISM frequency band they are operating in and the limits placed by the FCC and other governmental agencies for radios transmitting within these ISM frequency bands. One approach to increasing the range has been to place a greater number of traps in a network arrangement within which the traps communicate through one another, effectively forming a mesh network and/or acting as repeaters in relaying trap status information to a base station. A system of this type is disclosed in U.S. Pat. No. 9,743,657 which is owned by the assignee of the present invention and hereby expressly incorporated by reference herein as if fully set forth in its entirety.

Alternately, dedicated or stand-alone repeaters may be incorporated within a remote monitoring rodent control system. In both cases, the overall system is made more complex, requiring more time and effort to install and introducing greater instability due to the larger number of communication links required.

Therefore, a need exists for a system and method that enables electronic rodent traps to be monitored remotely over a much wider geographical area, eliminating the need for an infrastructure including repeaters and other intervening communication devices so that system set up is faster and easier and system stability is enhanced.

### SUMMARY OF THE INVENTION

Accordingly, the present invention is directed to a remote notification electronic rodent trapping system and method. The system includes one or more electronic rodent trapping devices having wireless communication capabilities using frequencies of less than 1 GHz and payloads of less than 256 bytes to enable the status of the traps to be remotely monitored over a wide geographical area. Particularly, the traps are capable of reporting their status to a base station or gateway as far away as ten miles or more, and to do so directly, i.e., without the use of repeaters. As a result, the system of the present invention allows for the monitoring of large commercial, urban, agricultural and residential areas while obviating the need for an infrastructure including complex networks of devices and repeaters.

The remote notification electronic rodent trapping system with long range monitoring capability according to the present invention is designed to work effectively with the rearming electronic killing traps disclosed in U.S. Pat. No. 6,836,999 (“the '999 patent’) which is also owned by the assignee of the present invention and hereby expressly incorporated by reference as if set forth in its entirety.

In view of the foregoing, one object of the present invention is to provide a remote notification electronic rodent trapping system and method with electronic rodent trapping devices having wireless remote notification capability that allows a user to monitor trap status through a base station or gateway device located at a distance of at least one mile or more, such as on the order of 2-10 miles away from each of the traps.

Another object of the present invention is to provide a remote notification electronic rodent trapping system and method that simultaneously monitors the status of a plurality of traps spaced at different locations from each other, the traps sending wireless communications to a gateway device using a frequency of less than 1 GHz.

Yet another object of the present invention is to provide a remote notification electronic rodent trapping system and method in accordance with the preceding objects in which the plurality of electronic rodent traps communicate with wireless transmissions each having a payload of not more than 256 bytes.

A further object of the present invention is to provide a remote notification electronic rodent trapping system and method in accordance with the preceding objects in which the plurality of traps communicate with public gateways operating on a like protocol in a manner like that between cell phones and cell towers.

A still further object of the present invention is to provide a remote notification electronic rodent trapping system and method in accordance with the preceding objects in which the traps communicate in a low power wide area network (LPWAN) such as LoRa, SigFox, Weightless, Ingenu and the like.

Yet another object of the present invention is to provide a remote notification electronic rodent trapping system and method in accordance with the preceding objects in which the system and method are embodied in accordance with one or more types of “cloud” computing.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a long range wireless notification electronic rodent trapping system in accordance with the present invention.

FIG. 2 is a block diagram of one of the traps and the gateway shown in FIG. 1.

FIG. 3 is a block diagram of a LPWAN illustrating various communication protocols that may be selected in creating the network in accordance with the present invention.

FIG. 4 is a flowchart of the method of operating the long range wireless notification electronic rodent trapping system in accordance with the present invention.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

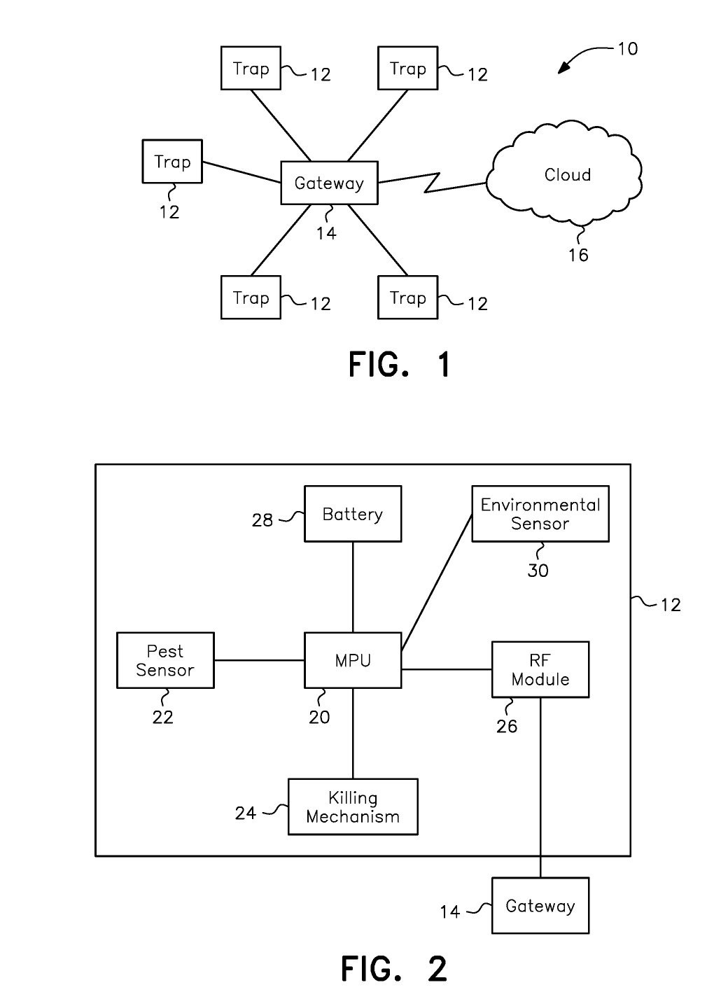

As shown in FIG. 1, the present invention is directed to a long range remote notification electronic rodent trapping system and network generally designated by reference numeral 10. The network 10 includes a plurality of electronic rodent trapping devices or traps 12 and a gateway 14 that can be arranged in a star-type network like that shown in which the traps communicate directly with the gateway 14 with no need for repeaters or intercommunication between the traps. The gateway can be configured to communicate with the cloud 16, enabling trap status to be monitored by users at virtually any location as is known by persons skilled in the art. As used herein, “traps” and “trapping devices” are used interchangeably. In addition, “electronic rodent trapping devices” is not intended to exclude trapping devices having other killing mechanisms, or no killing mechanism at all in the case of traps used to monitor rodent presence, provided the traps are configured for direct wireless communication with a gateway as described herein.

As shown in FIG. 2, each of the traps 12 includes a microprocessing unit (MPU) 20 in communication with a rodent sensor 22, a killing mechanism 24, and an RF module 26 by which the trap communicates with the gateway 14. The trap also has a power source such as battery 28 and may further include an environmental sensor 30 that can be used to collect data in areas in which placement of such a sensor or sensors, on a dedicated basis, might otherwise be inconvenient or impractical, such as crawl spaces, attics or other relatively inaccessible locations where traps are often used effectively. While not necessary, equipping the trap with an environmental sensor 30, such as for ambient temperature, provides an extra functionality at minimal cost and no additional effort in terms of installation in the field.

Upon detecting the presence of a rodent with the pest sensor 22, the MPU 20 activates the killing mechanism 24 to dispatch the rodent. Electronic rodent traps having a killing circuit operative with a MPU are disclosed in the '999 patent. In addition to the electronic rodent trapping devices disclosed in the '999 patent, the trapping devices 12 used in conjunction with the present invention may be of the types disclosed in U.S. Pat. Nos. 7,219,466; 7,690,147; and 7,757,430, all of which are owned by the assignee of the present invention and hereby expressly incorporated by reference as if set forth in their entirety. Therefore, the trapping devices described herein may be rearming traps having two or more killing plates, or may include other types of electronic or electro-mechanical traps configured to dispatch rodents, including either or both of mouse and rat killing capabilities. Use of the system and method set forth herein with traps that monitor rodent presence without a killing mechanism is also contemplated and therefore within the scope of the present invention.

The gateway 14 used by the trapping devices 12 may be a public gateway operating on a like protocol in a manner like that used with cellular devices in which cell phones communicate with cell towers not owned by the end user. Alternatively, the gateway 14 may be established by the owner of an individual system such that the network 10 over which the traps communicate is private. In this case, the owner purchases a long-range gateway and sets up a personal facility through which all of the trapping devices connect.

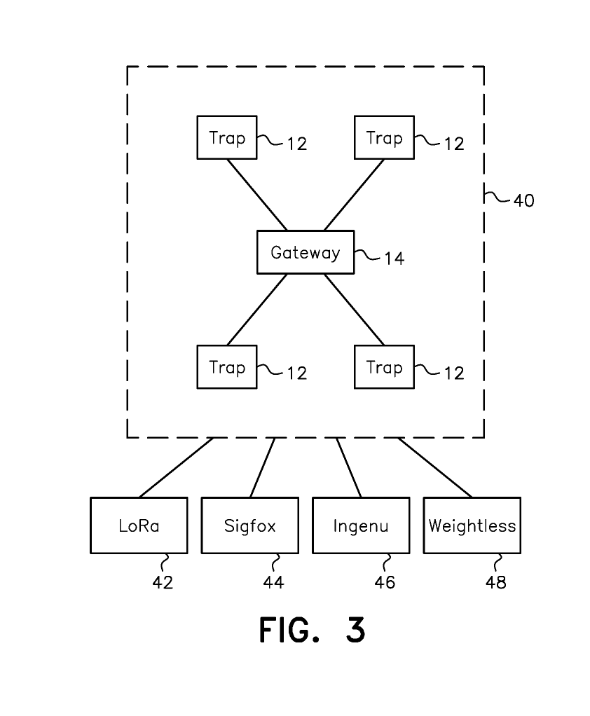

As depicted in FIG. 3, the traps 12 communicate with at least one gateway 14 preferably within a low power wide area network (LPWAN) 40. Depending on the communication protocol used, the LPWAN 40 may be a LoRa network 42, a Sigfox network 44, an Ingenu network 46, a Weightless network 48, or other network used to provide machine to machine connections in the manner described herein. In connection with FIG. 3, it is to be understood that the network types 42-48, which are shown as being “connected” to the LPWAN 40, are intended to represent, within a single drawing figure, alternative communication protocols that may be used individually in configuring the LPWAN 40.

According to the method of the present invention, the plurality of electronic trapping devices 12 send wireless transmissions including trap status data to the gateway 14. Using frequencies of less than 1 GHz, the traps are capable of reporting their status to the gateway over a distance of at least one mile away, with communication capability ranges extending outwardly on the order of up to about ten miles away, without the use of repeaters. The transmissions carry a small payload of not greater than 256 bytes, which optimizes range and battery life. As a result, the system of the present invention allows for the monitoring of large commercial, urban, agricultural and residential areas while obviating the need for an infrastructure including complex networks of devices and repeaters. By eliminating the need to install permanent network components, system setup is fast as well as easily modifiable.

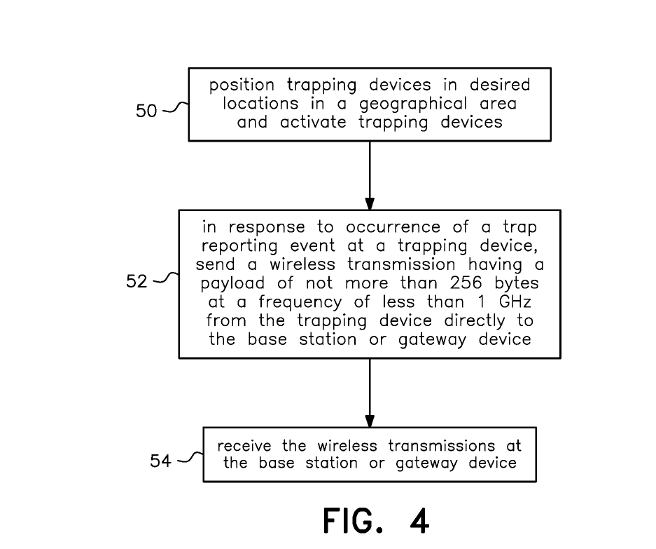

A flowchart of the method of remotely monitoring a plurality of electronic rodent trapping devices through a base station or gateway device in accordance with the present invention is set forth in FIG. 4. The method includes positioning a plurality of trapping devices in desired locations in a geographical area and activating the trapping devices, step 50; in response to the occurrence of a trap reporting event at a trapping device, sending a wireless transmission having a payload of not more than 256 bytes at a frequency of less than 1 GHz from the trapping device to the base station or gateway device, step 52; and receiving the wireless transmission at the base station or gateway device, step 54. The transmissions are sent directly to the base station or gateway device without using any intervening repeating devices. When positioning the plurality of trapping devices, the trapping devices may be in various locations at a range of up to 10 miles away from the base station or gateway device.

The occurrence of a trap reporting event, step 52, may include activation of the pest sensor 22, activation of the killing mechanism 24, the elapsing of a preset time period between periodic trap status update transmissions, a low battery condition, and the like, with the understanding that the system and method may be configured to define other occurrences as “reporting events”, i.e., events that initiate the sending of a trapping device transmission, as would be understood by persons of ordinary skill in the art. The operation of the trapping devices following a transmission depends upon the nature of the reporting event as well as the specific configuration of the trapping devices. Reference is made to the foregoing identified patents, previously incorporated by reference herein, for some of the possible trapping device operational configurations that may be implemented effectively and used with the long range wireless notification system and method for electronic rodents traps of the present invention.

The invention described herein provides an improved system and method for monitoring electronic rodent traps that provides greatly increased range in a way not previously considered applicable to the field of rodent control devices. In the case of public gateways, while cell phones use cell towers in like manner to that with which the traps can communicate through a gateway as described herein, it has not been known to use such technology with pest control devices that have a fixed location in use but which can be moved to and then used in a different location very easily, such as electronic rodent traps. The long range gateway and trap communication using long range radio frequency modules described herein provide a degree of flexibility and ease of set up and use not previously available or contemplated in connection with electronic rodent trap monitoring systems and methods.

Accordingly, the present invention has been described with some degree of particularity directed to the exemplary embodiments of the present invention. It should be appreciated, though, that other embodiments pertaining to long range wireless notification systems and methods for pest control devices distributed over a wide geographic area could be contemplated and modifications or changes made to the exemplary embodiments of the present invention without departing from the inventive concepts contained herein.

What is claimed is:

1. A remote notification electronic rodent trapping system comprising:
a base station or gateway device; and
a plurality of electronic rodent trapping devices, each of said rodent trapping devices including an RF module for sending wireless transmissions to the base station or gateway device at a frequency of less than 1 GHz, each wireless transmission having a payload of not more than 256 bytes, said frequency and payload size providing long range wireless remote notification capability while communicating directly with the base station or gateway device.

2. The remote notification electronic rodent trapping system as set forth in claim 1, wherein the plurality of trapping devices are spaced at different geographical locations from each other and can communicate directly with the base station or gateway at distances of up to at least one mile.

3. The remote notification electronic rodent trapping system as set forth in claim 2, wherein the plurality of trapping devices can communicate directly with the base station or gateway at distances of up to about 10 miles away from the base station or gateway.

4. The remote notification electronic rodent trapping system as set forth in claim 1, wherein the trapping devices communicate in a low power wide area network (LPWAN).

5. The remote notification electronic rodent trapping system as set forth in claim 4, wherein the LPWAN is a LoRa network.

6. The remote notification electronic rodent trapping system as set forth in claim 4, wherein the LPWAN is a Sigfox network.

7. The remote notification electronic rodent trapping system as set forth in claim 4, wherein the LPWAN is an Ingenu network.

8. The remote notification electronic rodent trapping system as set forth in claim 1, wherein the trapping devices are arranged in a star network topology.

9. The remote notification electronic rodent trapping system as set forth in claim 1, wherein each of the trapping devices further includes a pest sensor and a killing mechanism.

10. The remote notification electronic rodent trapping system as set forth in claim 9, wherein at least one of the trapping devices further includes an environmental sensor.

11. The remote notification electronic rodent trapping system as set forth in claim 1, wherein the plurality of trapping devices use public gateways.

12. The remote notification electronic rodent trapping system as set forth in claim 1, wherein the system is embodied in accordance with one or more types of cloud computing.

13. A method of remotely monitoring a plurality of electronic rodent trapping devices through a base station or gateway device comprising:
positioning the plurality of trapping devices in a geographical area;
sending wireless transmissions each having a payload of not more than 256 bytes from the trapping devices to the base station or gateway device at a frequency of less than 1 GHz; and
receiving the wireless transmissions at the base station or gateway device.

14. The method as set forth in claim 13, wherein the wireless transmissions are transmitted directly to the base station or gateway device without use of any intervening repeating devices.

15. The method as set forth in claim 14, wherein the trapping devices are placed at various locations at a range of up to 10 miles away from the base station or gateway device.

16. The method as set forth in claim 14, wherein the trapping devices communicate in a low power wide area network (LPWAN).

17. The method as set forth in claim 16, wherein the LPWAN is selected from the group consisting of a LoRa network, a Sigfox network and an Ingenu network.

18. The method as set forth in claim 13, wherein the step of sending wireless transmissions is taken in response to occurrence of a trap reporting event.

19. The method as set forth in claim 13, wherein the plurality of trapping devices communicate with public gateways.

20. The method as set forth in claim 13, wherein the method includes use of one or more types of cloud computing.
